(19) United States
(12) Patent Application Publication
(10) Pub. No.: US 2002/0186256 A1
(43) Pub. Date: Dec. 12, 2002

(54) Method and system for an integrated user interface that can effectively displays online data with limited browsing options

(76) Inventor: Tony Hong, Diamond Bar, CA (US)

Correspondence Address: Tony Hong, 1548 Silver Lane, Diamond Bar, CA, 91765, US

(21) Appl. No.: 09/876,247

(22) Filed: Jun. 8, 2001

(51) Int. Cl. G06F 3/14

(52) U.S. Cl. 345/817

(57) ABSTRACT

This invention generally relates to a method for an integrated and interactive navigating user interface, and more particularly, to a method for reformatting available online data and selections into interactive navigational toolbar and fields of displays.

### BACKGROUND OF INVENTION

The World Wide Web is becoming an increasing part of today's media. The growth in the online world can be attributed to its efficient data delivery and comprehensive coverage. Unlike traditional media, web pages use nonlinear hyperlinks that brings more comprehensive coverage on requested topic.

But while web pages usually deliver more comprehensive coverage than traditional media does, they are mostly optimized for computer monitor displays. That is, web pages usually require finer screen resolution and close viewing. This format is therefore not efficient when shown on limited display or when viewing from afar, such as on a television screen.

With its comprehensive lists of available topic selections and hyperlinks, traditional web pages furthermore complicate the browsing process when relying on limited navigational methods. That is, without a freely moving cursor such as a mouse, navigating through numerous selections could become time consuming without a simpler, directional navigational device.

Another shortcoming of web pages on limited screen display is that the requested content is often obscured or cluttered by the associated links and options available on the topic. While this reflects the comprehensive, nonlinear characteristics of online data delivery, it presents a more clustered content in display.

A new method for displaying online information over traditional or limited screen display is needed that combines the comprehensive functionality of online information with simplistic, directional navigation and browsing selections.

### SUMMARY OF INVENTION

The present invention provides a method and system for an integrated and interactive navigational user interface. More specifically, it reformats the two major distinct components of a web page, namely the topic selections and the content itself.

The topic selections may vary in format, among different web pages, but in essence the available options appear either as above page tabs or sidebars selections. Whereas this represents a detailed and random way of browsing, the present invention reformats available selections into a navigational toolbar that only display relevant available option when requested.

The navigational toolbar consists of a three buttons and a corresponding display area. For simplicity, the three buttons represent backward, present, and forward topic selection. The corresponding display, in respect to the topic per requested, extends to list a full range of selections comparable to the traditional web page format.

Another aspect of the present invention is to present the content in request of a web page in a simpler and faster navigating environment. To avoid crowding of complicate layout of a web page, contents are divided into horizontal rows in a grid. More specifically, their respective fields group text, graphics and other available data accordingly into different rows. This allows faster browsing and simpler navigating where each designated field of content occupies individual grids, and where additional contents follows in next page in the same row in the grid.

One aspect of the present invention regards to method of reformatting and displaying online information on higher-speed online connections. For an optimal corresponding interaction of content and navigational interface, the navigational toolbar is formatted to be a separate, yet supportive web page that can be accessed by differently. That is, similar to the frames on a web page where two groups of contents supports each other, navigational toolbar with interactive display can quickly display online data without requesting or changing the content grid.

What I claimed is:

1. A computer controlled method of providing an integrated and interactive navigational user interface, said computer controlled method comprising the steps of:
generating a screen display, including a plurality of partitions, generating at least a first partition for presenting web page contents in formatted girds;
generating concurrently with the first partition at least a second partition for presenting a plurality of navigational selections, said navigational selections including a backward selection, a current selection, and a forward selection;
determining data of said first partition to be marked utilizing grid location provided by selected browser;
processing said determined data which corresponds to said grid;
routing said processed data to said second partition; and
displaying said processed data at second partition in accordance with said navigation selections,
wherein said processing step comprises the steps of:
searching data within said web page contents for directory characteristics in accordance with said grid location;
generating a list of directory identifiers from said data;
obtaining data in said web page contents which corresponds to said selected browser;
generating a list of enhancement identifiers from said data;
searching data within said web page contents for hypermedia links; and
generating a list of optional identifiers from said data.

2. The method of claim 1 wherein the step routing said processed data further comprising the steps of:
obtaining said list of directory identifiers;
processing said list of directory identifiers with an evolving reference directory; and
storing said processed data in a data buffer;
wherein said processing step comprises the steps of:
matching said list of directory identifiers to a list of reference directory identifiers in said list of reference directory;
generating a list of enhancements data from said reference directory;
routing said list of enhancements data to the current navigational selection;
generating a list of options data from said reference directory; and
routing said list of options data to the forward navigational selection.

3. The method of claim 2, wherein said storing step further comprises the steps of:
invoking a directory area on display at the backward navigation selection;
invoking at least a user interactive HTML area on display at said current navigation selection; and
invoking an opinion selections area on display at said forward navigation selection.

4. The method of claim 1, wherein said presenting web page contents in formatted grids includes the step of reformatting page layout according to selectable fields of interests.

5. The method of claim 1, wherein said generating identifiers includes correlating content with extensible markup language.

6. The method of claim 2, wherein said evolving reference directory includes drawing directory data from an operating system.

7. The method of claim 2, wherein said evolving reference directory involves accumulating general topics, categories, or fields of interests.

8. A computer system for providing an integrated and interactive navigational user interface, said computer system comprising:
means for generating a screen display, including a plurality of partitions;
means for generating at least a first partition for presenting web page contents in formatted grids;
means for generating concurrently with the first partition at least a second partition for presenting a plurality of navigational selections, said navigational selections including a backward selection, a current selection, and a forward selection;
means for determining data of said first partition to be marked utilizing grid location provided by selected browser;
means for processing said determined data which corresponds to said grid;
means for routing said processed data to said second partition; and
means for displaying said processed data at second partition in accordance with said navigation selections.

9. The computer system of claim 8 wherein the means for processing data further includes:
means for searching data within said web page contents for directory characteristics in accordance with said grid location;
means for generating a list of directory identifiers from said data;
means for obtaining data in said web page contents which corresponds to said selected browser;
means for generating a list of enhancement identifiers from said data;
means for searching data within said web page contents for hyperlinks; and
means for generating a list of optional identifiers from said data.

10. The computer system of claim 8 wherein the means for routing said processed data further includes:
means for obtaining said list of directory identifiers;
means for processing said list of directory identifiers with an evolving reference directory; and
means for storing said processed data in a data buffer.

11. The computer system of claim 10 wherein the means for processing identifiers further includes:
means for matching said list of directory identifiers to a list of reference directory identifiers in said list of reference directory;
means for generating a list of enhancement data from said reference directory;
means for routing said list of enhancements data to the current navigational selection;
means for generating a list of options data from said reference directory; and
means for routing said list of options data to said the forward navigation selection.

12. The computer system of claim 10 wherein the means for storing data further includes:
means for invoking a directory area on display at the backward navigation selection;
means for invoking at least a user interactive HTML area on display at said current navigation selection; and
means for invoking an opinions selections area on display at said forward navigation selection.

13. The computer system of claim 8 wherein said formatted grids are organized in accordance with selected fields of interests.

14. The computer system of claim 8 wherein said identifiers are extensible markup language data.

15. The computer system of claim 10 wherein said reference directory includes directory data in an operating system.

16. The computer system of claim 10 wherein said reference directory involves general topics, categories, or fields of interests.
